(19) United States
(12) Patent Application Publication
(10) Pub. No.: US 2006/0066971 A1
(43) Pub. Date: Mar. 30, 2006

(54) System and method for ameliorating the effects of adjacent track erasure in magnetic data storage device

(75) Inventors: Michael Alex, Fremont, CA (US); Hideki Zaitsu, Odawara-shi (JP)

Correspondence Address: ROGITZ & ASSOCIATES, 750 B STREET, SUITE 3120, SAN DIEGO, CA, 92101, US

(73) Assignee: Hitachi Global Storage Technologies Netherlands B.V.

(21) Appl. No.: 10/956,898

(22) Filed: Sep. 30, 2004

(51) Int. Cl. G11B 27/36; G11B 5/09

(52) U.S. Cl. 360/31; 360/53

(57) ABSTRACT

To ameliorate the effects of ATE in a HDD, tracks that are potential victim tracks of an aggressor track by virtue of the victim tracks being exposed to a magnetic field associated with a write of the aggressor track are preemptively rewritten after an empirically-determined number of writes to the aggressor track, with the empirically-determined number of writes being selected to ensure that the cumulative effects of aggressor writes do not rise to the level that would be expected to result in a significant amount of lost data on the victim tracks. Alternatively, potential victim tracks can be scanned for error rates and if any error rates violate a threshold, the victim tracks can be rewritten when the disk is idle.

### I. FIELD OF THE INVENTION

The present invention relates generally to hard disk drives.

### II. BACKGROUND OF THE INVENTION

In hard disk drives (HDD), deleterious effects can occur that are known as “adjacent track erasure” (ATE), “adjacent track interference” (ATI), and “side writing/side erasure” (herein collectively referred to as AATE@). These phenomena are all caused by inadvertent erasure of data that is underneath certain portions of the recording head during disk drive operation. There are presently no known solutions to this problem, other than to discard a head known to cause ATE and to design heads such that ATE effects are minimized, but due to process and material variations, a head designed to produce little or no ATE may still exhibit poor ATE performance, that is, cause inadvertent erasure of victim data tracks in the drive. Generally, ATE is not a serious issue in the short term for nominally good head designs, but repeated use of the head in the drive causes gradual performance degradation over time because data on adjacent tracks is increasingly erased as the head is used.

To avoid long term drive failure, heads are designed such that no ATE failure occurs in the short term, or heads that are considered marginal are discarded and never used in drives. Because of this, head designs are optimized and constrained to insure good short term performance, which means that recording performance will be compromised, since reducing the effects of ATE requires design modifications that can negatively impact other recording performance metrics, like so-called overwrite (OW). In addition, as mentioned above “marginal” heads that may or may not cause ATE in the long run are discarded during testing and sorting, causing lower head yields. The present invention recognizes that the effects of applied stray fields are cumulative in nature with well-known characteristics, and that a victim track that is affected by writes to another track may or may not be immediately adjacent to the written track, depending on the geometry of the head. Generally speaking, regardless of where the affected track is, the amplitude decay is logarithmic with the number of exposures to the field.

With more specificity, ATE may be caused to immediately adjacent tracks to a written track, and in perpendicular recording to tracks near the edges of the return pole, which is relatively larger than the main pole and accordingly the edges of which can be distanced from the track being written (the track under the main pole). Further, ATE can be caused to tracks near the edges of head shields, which can occur not just during writes but also if the head is placed in a global field of sufficient amplitude. Having made these critical observations, the invention herein is provided.

### SUMMARY OF THE INVENTION

A controller for a hard disk drive (HDD) that can use longitudinal recording or perpendicular recording is provided that executes logic. The logic may be to correlate an aggressor track on a disk of the HDD to at least one victim track on the disk, and then to count a number of times the aggressor track is written to. When the number of times violates a threshold, data on the victim track can be rewritten. In addition or as an alternative, the logic may include scanning a victim track for errors, and if the errors exceed a threshold, determining that the victim track must be rewritten. In this latter embodiment, the error rate of the victim track can be scanned at predetermined intervals or after a predetermined number of writes. In various implementations a track can be considered to be a victim track of an aggressor track by virtue of the victim track being exposed to a magnetic field associated with a write of the aggressor track.

In another aspect, a hard disk drive (HDD) determines that a rewrite condition has been met for at least a first data track due to aggressor writes of a nearby data track which potentially expose the first data track to stray magnetic flux. The HDD can in response rewrite data on the first data track.

In still another aspect, a chip is disclosed for a hard disk drive (HDD) which has data tracks. At least one victim track is correlated to at least one aggressor track by virtue of the victim track being expected to receive exposure to stray magnetic flux when the aggressor track is written to. The chip can include means for determining whether a rewrite condition has been met, and means for rewriting data stored on the victim track back to the victim track, in response to the means for determining.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a perspective view of an exemplary embodiment of the present magnetic storage device, configured as a hard disk drive, with portions of the housing broken away;

FIG. 2 is a flow chart of a first embodiment of the present logic; and

FIG. 3 is a flow chart of a second embodiment of the present logic.

### DETAILED DESCRIPTION OF THE PREFERRED EMBODIMENT

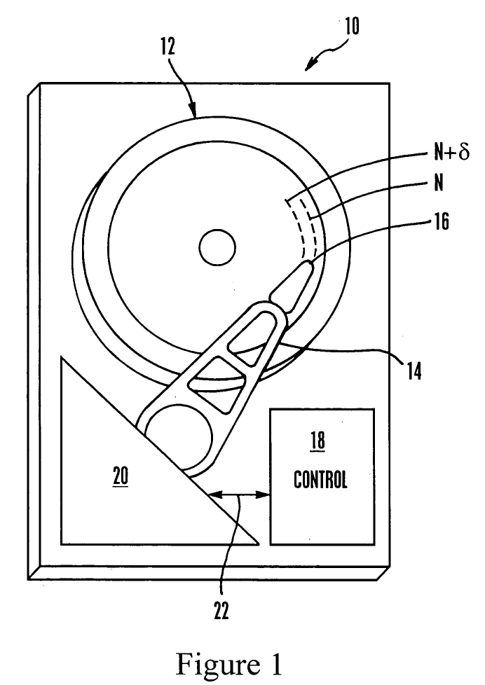

Referring initially to FIG. 1, a magnetic data storage device is shown, generally designated 10, for storing data on a storage medium 12 that in one embodiment may be implemented by plural storage disks in a hard disk drive (HDD). When implemented as a hard disk drive, the device 10 includes an arm 14 having a read/write head 16 (part of what is colloquially referred to as a “slider”) on the end thereof in accordance with hard disk drive principles. The data storage region 12 may be managed by a controller 18 that can be a conventional hard disk drive controller implemented as a chip and modified per the logic below. The controller 18 controls an electromechanical actuator 20 by sending signals over a path 22 in accordance with principles known in the art to read data from and to write data to the disks 12.

As shown in FIG. 1, when it is desired to write data to some track N, the write head (e.g., the main pole of a perpendicular recording head, it being understood that the principles advanced herein apply to both perpendicular and longitudinal recording) is positioned over the track N and the write is executed. As mentioned above, one or more nearby tracks N+δ (where δ is a positive or negative integer) might experience stray magnetic fields when the N^{th} track is written, thereby potentially causing ATE in the track or tracks N+δ. Under these circumstances, the N^{th} track being written can be considered to be an “aggressor” track, and any adjacent tracks that are potentially affected by the writing of the N^{th} track can be considered to be “victim tracks” associated with the aggressor track N.

The present invention understands that data erasure on victim tracks from stray fields caused by writes to aggressor tracks, which leads to amplitude loss (and noise increase), is not always an abrupt catastrophic process. In other words, the drive may perform adequately for many data writes on track N and there may be no failure on any adjacent tracks until very many writes has taken place.

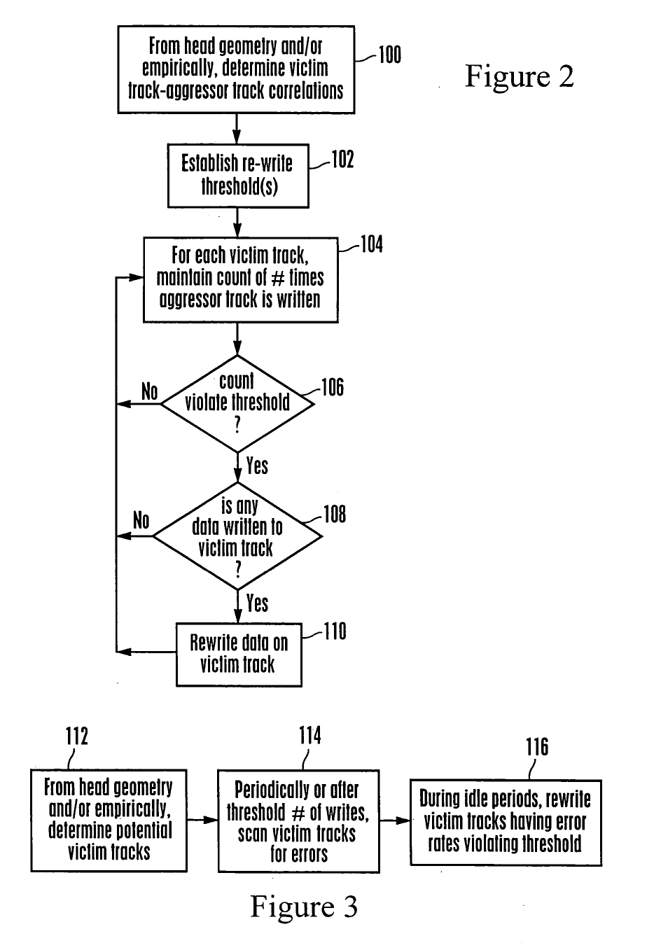

With this recognition in place and referring now to FIG. 2, victim track-aggressor track correlations can be made at block 100. This can be done in accordance with principles set forth above empirically or experimentally by characterizing the drive and its components: head, media, the physical crosstrack locations of regions that may be erased due to ATE effects, etc. In this way, for writes to each track (an Aaggressor track@ when it is being written to), it can be determined which other track or tracks (the Avictim@ tracks) can experience ATE, with each track consequently being a potential aggressor track when it is written to and a potential victim track when another track nearby is written to.

Once the aggressor track-victim track correlations have been obtained, the logic moves to block 102 to establish a threshold number of writes to an aggressor track beyond which the associated victim tracks might be expected to experience degradation and, hence, require rewrite as set forth more fully below. A single threshold can be used for all potential victim tracks, or each potential victim track can have its own threshold determined in cases where system geometry might produce ATE in some tracks with fewer aggressor writes than would produce ATE in other tracks. The value of the threshold may be determined experimentally and set conservatively to ensure that as long as a rewrite is performed as discussed below, the likelihood of data loss of significance due to ATE is minimized.

After making the determinations at blocks 100 and 102, the HDD can be provided to a user and the logic can flow to block 104 to keep track of the number of writes performed on each track, and, hence, the total number of “aggressor writes” each nearby track, in its role of victim track, has been the victim of. That is, for each potential victim track, the number of times any associated aggressor tracks are written are counted at block 104.

At decision diamond 106 it is determined whether any victim track count violates the threshold. If the count does not violate the threshold number, then the logic loops back to block 104 to continue to count the number of times potential aggressor tracks are written. In contrast, if the number of aggressor writes experienced by a potential victim track equals or exceeds or otherwise violates the threshold that was established at block 102, the victim track will be examined, at decision diamond 108, to see if any data previously has been written to the victim track. If so, then the data on this track is rewritten at block 110, preferably back to the same track, substantially before there is any danger of data loss. If no data is written to the victim track or from decision diamond 108 if the test there was negative, the logic loops back to block 104.

Referring now to FIG. 3, instead of determining in detail the exact degree of correlation between aggressor tracks and victims tracks that might cause data loss on potential victim tracks, the range of writes that might produce ATE can be given lower and upper bounds at block 112 and the potential victim tracks determined from head geometry in accordance with principles set forth above. Periodically or when within the range of the total number of writes to the disk that can result in ATE to some victim track as determined at block 112, the potential victim tracks are scanned for errors at block 114. More generally, potential victim tracks are scanned for errors using, e.g., error rate determination principles known in the art, based on some heuristic rule. Regardless of what prompts the scanning, if the error rate of any track violates a threshold, the track is rewritten with the same data as it held before at block 116. As indicated in FIG. 3, this rewrite process, generally speaking, can be lengthy if it is desired to scan and rewrite the entire drive, and so it advantageously can be programmed to be done when the drive is not being used, i.e., when the drive is idle.

While the particular SYSTEM AND METHOD FOR AMELIORATING THE EFFECTS OF ADJACENT TRACK ERASURE IN MAGNETIC DATA STORAGE DEVICE as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. '112, sixth paragraph, unless the element is expressly recited using the phrase “means for” or, in the case of a method claim, the element is recited as a “step” instead of an “act”. Absent express definitions herein, claim terms are to be given all ordinary and accustomed meanings that are not irreconciliable with the present specification and file history.

1. A controller for a hard disk drive (HDD) and executing logic, the logic comprising:
correlating at least one aggressor track on a disk of the HDD to at least one victim track on the disk;
scanning at least one victim track for errors; and
if the errors violate a threshold, determining that the victim track must be rewritten.

2. A controller for a hard disk drive (HDD) and executing logic, the logic comprising:
correlating at least one aggressor track on a disk of the HDD to at least one victim track on the disk;
counting a number of times the aggressor track is written to; and
when the number of times violates a threshold, rewriting data on the victim track.

3. The controller of claim 2, comprising determining whether a victim track holds any data, prior to executing the rewriting act.

4. The controller of claim 2, wherein a track is a victim track of an aggressor track by virtue of the victim track being exposed to a magnetic field associated with a write of the aggressor track.

5. The controller of claim 2, wherein the logic includes:
scanning at least one victim track for errors; and
if the errors violate a threshold, determining that the victim track must be rewritten.

6. The controller of claim 5, wherein a track is a victim track of an aggressor track by virtue of the victim track being exposed to a magnetic field associated with a write of the aggressor track.

7. The controller of claim 5, wherein the victim track is scanned at predetermined intervals.

8. The controller of claim 5, wherein the victim track is scanned after a predetermined number of writes.

9. The controller of claim 1, wherein the victim track is scanned for an error rate.

10. The controller of claim 1, wherein the logic includes rewriting any victim tracks having errors violating the threshold only when the HDD is idle.

11-16. (canceled)

17. A chip for a hard disk drive (HDD) having data tracks, wherein at least one victim track is correlated to at least one aggressor track by virtue of the victim track being expected to receive exposure to stray magnetic flux when the aggressor track is written to, comprising:
means for determining whether a rewrite condition has been met; and
means for rewriting data stored on the victim track back to the victim track, responsive to the means for determining.

18. The chip of claim 17, wherein the rewrite condition is a number of writes to the aggressor track.

19. The chip of claim 17, wherein the rewrite condition is an error rate associated with the victim track.

20. The chip of claim 17, wherein the error rate is determined at predetermined intervals.

21. The chip of claim 17, wherein the error rate is determined after a predetermined number of writes.
